(19) United States
(12) Patent Application Publication
(10) Pub. No.: US 2012/0310911 A1
(43) Pub. Date: Dec. 6, 2012

(54) Search Engine Identifying Chemical Products

(75) Inventor: James J. Harrison, West Hills, CA (US)

(73) Assignee: Chemsill Silicones, Inc., Chatsworth, CA (US)

(21) Appl. No.: 13/509,570

(22) PCT Filed: Nov. 12, 2010
(86) PCT No.: PCT/US10/56570

§ 371 Date: Jul. 31, 2012

Related U.S. Application Data
(60) Provisional application No. 61/261,230, filed on Nov. 13, 2009.

(51) Int. Cl. G06F 17/30

(52) U.S. Cl. 707/706; 707/E17.108

(57) ABSTRACT

Systems and methods for efficiently searching a businesses' product inventory using competitor's trade name information as a search term to find relevant results. Such a system is for use on a general purpose computer in the form of a search engine using a user interface, a directory store of product information, according to a predetermined taxonomy and a way to display, print, or otherwise deliver search results.

### RELATED APPLICATION

This application claims the benefit of U.S. Provisional Application Ser. No. 61/261,230, filed Nov. 13, 2009, the entire contents of which are incorporated by reference herein.

### FIELD OF THE INVENTION

The present invention relates to the field of searchable directories. Particularly to searchable online directories, and more particularly, to adaptable and dynamic search engines for use with online business directories.

### BRIEF DESCRIPTION OF PRIOR DEVELOPMENTS

The Internet has proven itself to be an extremely effective communication medium. It is therefore not surprising that there is a sharp increase in the number of businesses or providers of goods that employ the Internet for the sale of their goods, making the Internet space very competitive. Generally, such businesses have varied offerings that include a wide range of products and/or services.

In order to be more competitive and to offer an advantage over other businesses in the same business niche, some business websites sometimes offer users access to searchable databases that maintain a variety of data and information. Generally, unless the business is itself a directory or knowledge resource-based business, the search function offers a search of the content of the business' own website or occasionally of helpful resource documents that give guidance to the user concerning the use of the businesses own products.

For example, databases containing indexed and categorized document listings, such as, a document directory. Typically, such internet-based document directories take the form of a computing application providing, among a variety of other functions, the ability to search a library of documents maintained within a database on the business' (or a contractor's) own servers or other computers. The search component of this application allows users to search by a number of search qualifiers, such as, the title of the document, the subject classification of the document, by text within the document, and so forth.

Chemical databases exist and usually follow the same model. For example The Chemical Database is maintained at the Department of Chemistry at the University of Akron (http://ull.chemistry.uakron.edu/erd/) (accessed Nov. 9, 2010). This searchable database, present on a server or other computer by, or under the authorization of the University of Akron) is accessible by a user using a general-purpose computer through the World Wide Web. The search page has four boxes affecting the search.

The first box, entitled Match, has the following options: “All”, “Any”, and “Boolean”. This option allows a user to select how a multi-word search query should be treated by the search application; that is, respectively, whether a search result (or “hit”) should contain all the words of the search term, whether every hit containing any word of the search term should be returned and displayed, or whether a search query using Boolean logic (permitting more advanced search parameters) should be returned.

The second box is termed “Format”, and has two options: “Long” and “Short”. These terms refer to whether the search results should be displayed by title only (“Short”) or in context within two or three lines of the document or web page referencing the chemical compound. The titles are hyperlinked, and permit the user to open the web page correlated to the title for more detailed information, such as the physical properties, and safety information concerning the compound.

The third box, entitled “Sort”, allows the user to choose the order in which the hits are displayed: Score (or relevance), Time, Title, Reverse Score (or most irrelevant first), Reverse Time, or Reverse Title.

The fourth box is for writing the search term itself.

As indicated above, the type of information obtained from The Chemical Database provides the chemical structure, the common uses of the compound, a list of US and non-US Registry Numbers and Inventories, the physical properties of the compound, and safety, health and fire related information concerning the use of the compound. However, this database is not of particular help if a prospective purchaser of a chemical compound wishes to quickly compare product names, prices or availability of such compounds.

This is because certain chemical compounds, for example many chemicals used in the cosmetic industry, have a variety of names and are identified with various registry names and numbers, manufacturer names and numbers, and other identification numbers.

Internet based chemical directories generally rely on chemical information grouped according to general category schemes that provide little insight, if any, to the specific products (such as trade names) marketed by a given business for chemicals within these categories. Thus, searchable on-line chemical directories that use such content perform de minimus operations often regurgitating the chemical search results according to the general category scheme. For example, a search for “methane” in this type of chemical directory may result in a list of all of the documents or web pages within the directories, database having the word “methane”. As such these chemical directories often leave a user hoping to purchase a particular chemical product to navigate through volumes of unhelpful results, rendering the initial search almost futile. In addition, current business-oriented chemical directory search engines often have complicated and cumbersome user interfaces that require the user to input a significant amount of preference information before performing the search.

From the foregoing it can be appreciated that a need exists for search engines accessible at a chemical business' website that are capable of efficiently providing more relevant and useful information to users, particularly to users wishing to select a appropriate product marketed by the business. In particular, it would be very useful for a chemical business' website to comprise a search engine which receives search term input such as a chemical name, registry name or number, or a competitor's name or number for the chemical to find an identical or equivalent chemical or chemical formulation and made by the chemical business, and the tradename of such a formulation. Additional data, including a summary of the physical and chemical properties and uses of the chemical(s) found in the search results would also be of considerable value. By tailoring a search engine to provide more relevant data that in a more efficient manner, users are required to refer to other directories or websites to obtain the desired search results.

### DETAILED DESCRIPTION OF THE INVENTION

The term “internet” refers commonly to the collection of networks and gateways that utilize the TCP/IP suite of protocols, which are well-known in the art of computer networking. TCP/IP is an acronym for “Transport Control Protocol/Interface Program,” a software protocol developed by the Department of Defense for communication between computers. The Internet can be described as a system of geographically distributed remote computer networks interconnected by computers executing networking protocols that allow users to interact and share information over the networks. Because of such wide-spread information sharing, remote networks such as the Internet have thus far generally evolved into an “open” system for which developers can design software applications for performing specialized operations or services, essentially without restriction.

Electronic information transferred between data-processing networks is usually presented in hypertext, a metaphorical term for presenting information in a manner in which text, images, sounds, and actions become linked together in a complex non-sequential web of associations that permit the user to “browse” through related topics. These links are often established by both the author of a hypertext document and by the user, depending on the intent of the hypertext document.

The term “hypermedia,” on the other hand, focuses on the non-textual components of hypertext, such as animation, recorded sound, and video. Hypermedia is the integration of graphics, sound, video, or any combination thereof into a primarily associative system of information storage and retrieval. Hypermedia, as well as hypertext, especially in an interactive format where choices are controlled by the user, is structured around the idea of offering a working and learning environment that parallels human thinking—that is, an environment that allows the user to make associations between topics rather than move sequentially from one to the next, as in an alphabetic list. Hypermedia, as well, as hypertext topics, are thus linked in a manner that allows the user to jump from one subject to other related subjects during a search for information. Hyper-link information is contained within hypermedia and hypertext documents, which allow a user to move back to “original” or referring network sites by the mere “click” (i.e., with a mouse or other pointing device) of the hyperlinked topic.

A typical networked system that utilizes hypertext and/or hypermedia conventions follows a client/server architecture. The “client” is a member of a class or group that uses the services of another class or group to which it is not related.

Thus, in computing, a client is a process (i.e., roughly a set of instructions or tasks) that requests a service provided by another program. The client process utilizes the requested service without having to “know” any working details about the other program or the service itself. In a “client/server” architecture, particularly a networked system, a client is usually a computer that accesses shared network resources provided by another computer (i.e., a server).

A client application program can send a request by a user to a server. A server is typically a remote computer system accessible over a remote network such as the Internet. The server scans and searches for information sources. Based upon such requests by the user, the server presents filtered electronic information as server responses to the client process. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by Hypertext-Transfer Protocol (HTTP). The World Wide Web (WWW) or, simply, the “Web,” includes those servers adhering to this standard (i.e., HTTP) which are accessible to clients via a computer or data-processing system network address such as a Universal Resource Locator (URL). The network address can be referred to as a Universal Resource Locator address. For example, communication can be provided over a communications medium. In particular, the client and server may be coupled to one another via TCP/IP connections for high capacity communication. Active within the client is a software application known as a “browser,” which establishes the connection with the server and presents information to the user. The server itself executes corresponding server software that presents information to the client in the form of HTTP responses. The HTTP responses correspond to “web pages” constructed from a Hypertext Markup Language (HTML), or other server-generated data. Each web page can also be referred to simply as a “page.”

The client typically displays the information provided through the network by the server through the browser application. Most browsers have modern graphical user interfaces that are capable of displaying and manipulating various types of data. A graphical user interface is a type of display format that enables a user to choose commands, start programs, and see lists of files and other options by pointing to pictorial representations (icons) and lists of menu items on the screen. Choices can be activated generally either with a keyboard or a mouse. Internet services are typically accessed by specifying a unique network address (i.e., typically with a Universal Resource Locator). The Universal Resource Locator address has two basic components, the protocol to be used and the object pathname. For example, the Universal Resource Locator address, “http://www.uspto.gov” (i.e., home page for the U.S. Patent and Trademark Office), specifies a hypertexttransfer protocol (“http”) and a pathname of the server (“www.uspto.gov”). The server name is associated with one or more equivalent TCP/IP address.

Free or relatively inexpensive “server” based computer software applications such as Internet “search engines” make it simple for a user to find information on a topic of interest or obtain specific content within a content offering, in the case of a directory listing search engine. A person may type in a subject or key word and generate a list of desired results. However, a problem associated with these types of Internet “search engines” is simply dealing with the vast amount of potential data that may be searched and retrieved. In many cases the search engine will discover unwanted data in addition to the desired data, thereby forcing the user to wade through often useless and unwanted search results in order to get to the desired data.

From the foregoing it can be appreciated that a need exists for tailoring search engines. By tailoring a search engine to the desires of a particular user class, a user falling within that class can essentially utilize the tailored search engine to access desired information while filtering unwanted data or information altogether. Moreover, for businesses having an Internet website a tailored search engine which permits potential customers to easily and quickly access only the data they wish, using search terms that they are most likely to use is clearly a competitive advantage and can be a major factor leading to increased business sales.

The present invention was developed to provide a business-based search engine for chemical product listing data utilizing search terms such as, without limitation, one or more of chemical name, competitors' chemical names and/or identifying numbers, trade names and/or other commonly used identifying terms (including, for example, desired uses and properties) and correlates these search terms with the businesses own products and/or product properties and/or specifications. Such a search engine offers more relevant and reliable search results for prospective customers of chemical compounds and formulations from the business.

In an illustrative embodiment, the search engine is accessed by a client on the Internet at the business website of a vendor of chemical products and supplies. The search engine employs a unique decision matrix that delivers results faster, and more importantly, the “right” results for the user. The engine, residing on a server relies on an algorithmic series of analytical steps, correlation with a weighted taxonomy of categories and keywords, and tuned processing of queries against a physical data store. The taxonomy is structured in a manner wherein similar data may be grouped according to pre-defined categorizations, where the categories themselves are associated with each other. The groupings may be represented through various nodes. The nodes having associations with each other and with the individual data maintained with the nodes.

The search engine may employ one or more of various search processes when processing search queries. These search processes may include, without limitation, the use of keywords, a picker, lead nodes (best leaf node), and desired chemical attributes. Keywords are unique synonyms (“shortcuts”) for any node in the category taxonomy. For example, the keyword “methyl” may be a shortcut for a general category describing all compounds containing the word “methyl’ in their IUPAC, common, or International Nomenclature of Cosmetic Ingredients (INCI), or competitive product name. The picker is part of the search interface where a user is prompted to choose from a list of categories and enter a compound class preference.

As mentioned, the taxonomy construct may maintain various levels. Generally leaf nodes (a node of a data tree structure having no child nodes) may correlate with standardization codes (e.g., without limitation, one or more of the common chemical name, IUPAC (international Union of Applied and Pure Chemistry) nomenclature, International Nomenclature of Cosmetic Ingredients (INCI) nomenclature, chemical and physical properties and attributes, health and safety information, application of the and competitor's numbers and or trade names) and ultimately, with the business' own chemical product names. Each of these standards require data to be categorized according to a predefined set of rules. Within this taxonomy, higher level nodes are collections of leaf nodes. For example, “Sodium Acryloyl Dimethyl Taurate Copolymer” may be a leaf node having a parent category of “dimethyl” with a further parent of “methyl”. Similarly, the INCI name “EMULSIL® WO-5115 (Cyclopentasiloxane (and) PEG/PPG-18/18 Dimethicone) may be a leaf node having a parent category containing “5225C” (Dow Corning 5225C Formulation Aid”). The same leaf node may have a parent category of EMUSIL°.

In addition, the search engine may perform searches on the chemical name/business trade name listings using desired chemical attributes. That is, a particular chemical formulation may have unique attributes that may separate it from at least one other chemical formulations. Extended chemical attributes may include, brand or trade name of products carried by the business, INCI name, solubility, miscibility, molecular weight, viscosity, boiling point, melting point and final product uses, such as in lotions, sunscreens, emulsions, and the like. The search engine application may, in certain embodiments, process a user's search query by looking for these extended chemical characteristics.

In an illustrative implementation, the search engine of the present invention may be implemented by way of a business' web site. In operation, the search engine provides users with a simple to use data entry graphical interface that accepts search queries directed to chemical listing information, such as INCI name, the business' own product name, competitive product name, or chemical attribute. The search engine of the present invention generally cooperates with a server-accessed database having chemical listing information stored according to a pre-defined data taxonomy. The taxonomy is structured such that there are numerous interrelated and associated category levels that contain pre-defined chemical and chemical formulation classification and listings information. Using a series of pre-defined rules, the YP search engine searches the chemical and chemical formulation listing store employing taxonomy based processes and tries to find either direct matches or matches that are pre-correlated to the submitted query.

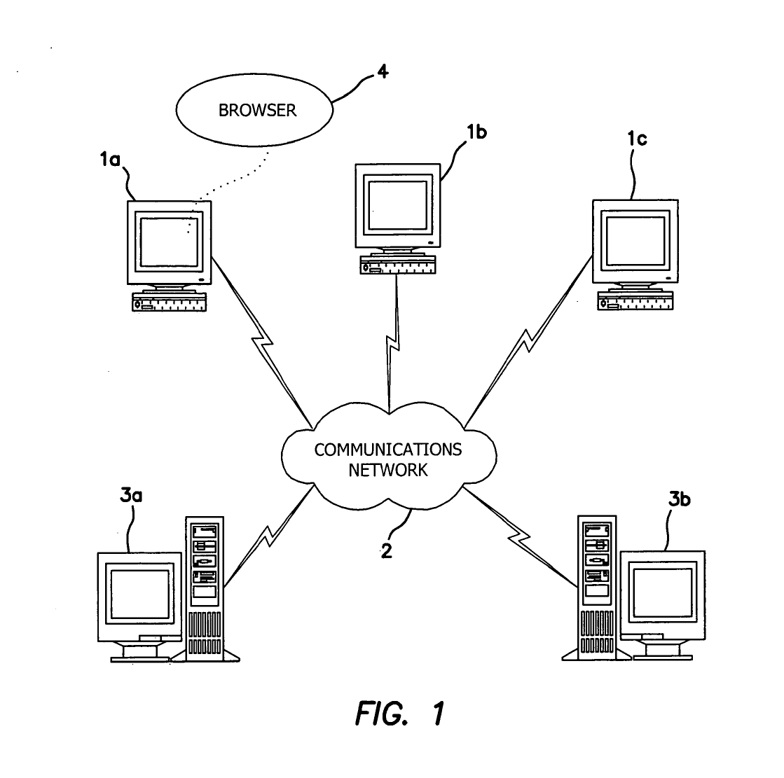

As will be described below with respect to FIGS. 1-6F, the present invention is directed to a system and methods for the searching of chemical and chemical formulation listing information hosted on a computing system. In accordance with an illustrative embodiment thereof, the present invention comprises a system and method to provide users the ability to search a business' chemical and chemical formulation listing information using search terms comprising, for example, competitor's product names or numerals, common name, INCI name, chemical attribute keywords, or even the business own product name as for desired list information.

### Example 1

The present invention may be deployed as part of a computer network. In general, the computer network may comprise both one or more server computers and one or more client computers deployed in a network environment. FIG. 1 illustrates an exemplary network environment, with a server in communication with client computers via a network, in which the present invention may be employed. As shown in FIG. 1, a number of servers 1a, 1b, etc. are interconnected via a communications network 2 (which may be a LAN, WAN, intranet or the Internet) with a number of client computers 3a, 3b, etc. In a network environment in which the communications network 2 is the Internet, for example, the servers 3 can be Web servers with which the clients 1 communicate via any of a number of known protocols such as hypertext transfer protocol (HTTP). Each client computer 1 can be equipped with a browser 4 to gain access to the servers 3.

Thus, the present invention can be utilized in a computer network environment having client computers for accessing and interacting with the network and a server computer for interacting with client computers. However, the systems and methods for providing more relevant directory listings search results of the present invention can be implemented with a variety of network-based architectures, and thus should not be limited to the example shown. The present invention will now be described in more detail with reference to a presently illustrative implementation.

### Example 2

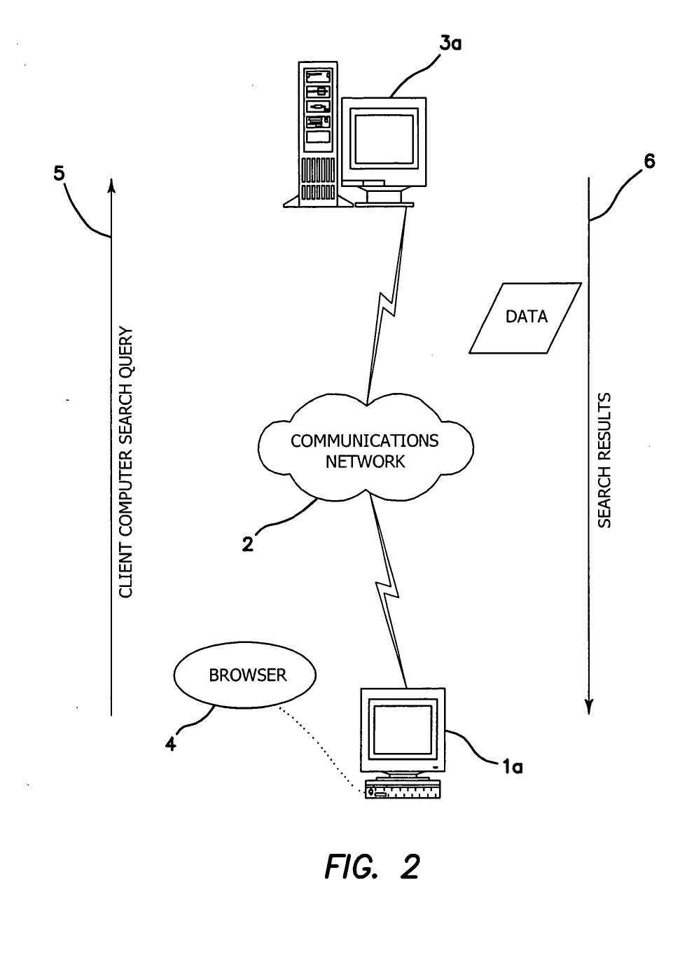

In FIG. 2 the interactivity between the client computer 1a and server computer 3a, running a browser during a search is shown. Client computer 1a is electronically coupled to communications network 2. Similarly, content provider's server 3a is electronically coupled to communications network 2. In operation, client computer 1a may communicate information to content provider's server 3a over communications network 2 and vice versa. For example, client computer may send a search query 5 for processing by content provider's server 3a over communication 2. In response, content provider's server 3a may process the search query 5, and transmit back to client computer 1a over communications network 2 search results 6. Search results 6 may comprise various data that may be processed and displayed by browser 4 on client computer 1a.

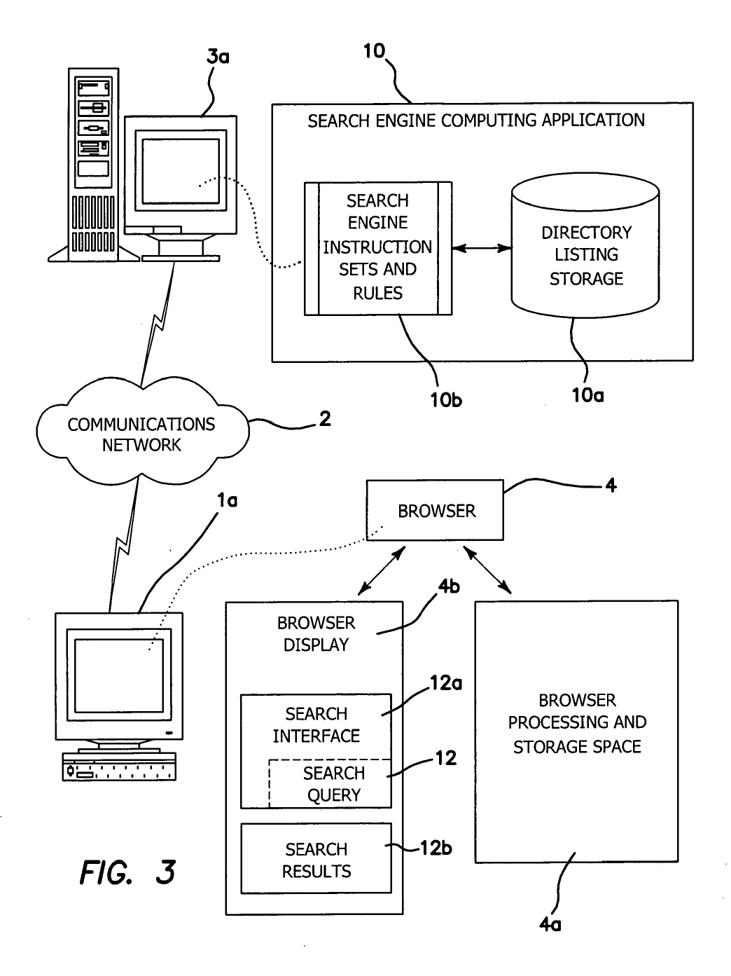

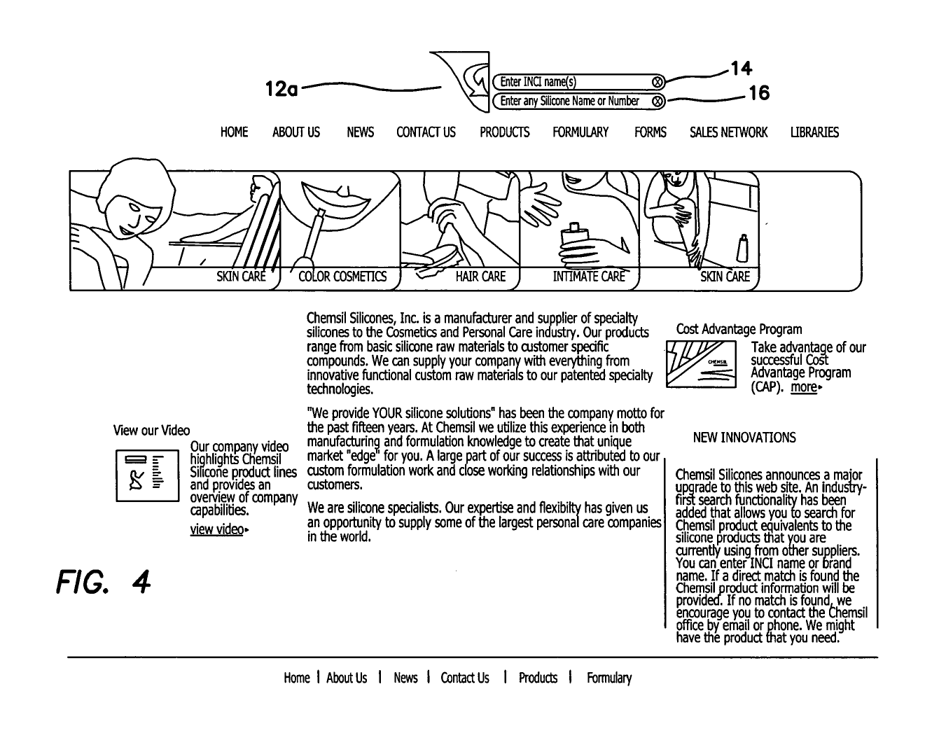

In FIG. 3 are shown the components with client computer 1a and content provider's server 3a to realize the exchange of information. As shown, client computer 1a maintains browser 4. Browser 4 comprises browser processing and storage space 4a and browser display 4b. Data may be received by client computer 1a and passed to browser 4. In turn, browser 4 processes the data in browser processing and storage space 4a for display on browser display 4b. Further, FIG. 4 shows content provider's server 3a maintaining the instant search engine computing application 10. Search engine computing applications comprises a chemical directory listing storage 10a and search engine instructions sets and rules 10b. Chemical directory listing storage 10a cooperates with search engine instructions sets and rules 10b such that chemical listing data is retrieved from chemical directory listing storage 10a according to search engine instruction sets and rules 10b.

In operation, client computer 1a may accept search query 12 from a cooperating user (not shown) through search interface 12a of browser 4. In turn, browser processing and storage space 4a may process search query 12 so that it may be communicated to content provider's server 3a over communications network 2 for processing. Content provider's server 3a may receive search query 12 and pass it to search engine computing application 10 for processing. Search engine computing application 10 processes search query 12 to retrieve relevant search results 12a using search engine instruction sets and rules 12b. Search results 12b are gathered by search engine computing application 10 and communicated to browser 4 of client computer 3a over communications network 4. Browser 4 displays search results 12b in browser display 4b.

FIG. 4 shows an embodiment of a basic search interface 12a containing two dialog boxes: a chemical name dialog box 14 in which a user may enter some or all of the INCI chemical name for a chemical compound or formulation, and a competitive name dialog box 16 in which a user may enter a competitor's trade name or number, corresponding to a competitor's product to see of it matches the business' or content provider's list of chemical and chemical formulation products. Those of ordinary skill in the art recognize that additional dialog boxes and/or categories of information for one or more dialog box may easily be added, and routine variations can easily be made. However, in a preferred embodiment the competitive product search capability is an important feature of the invention.

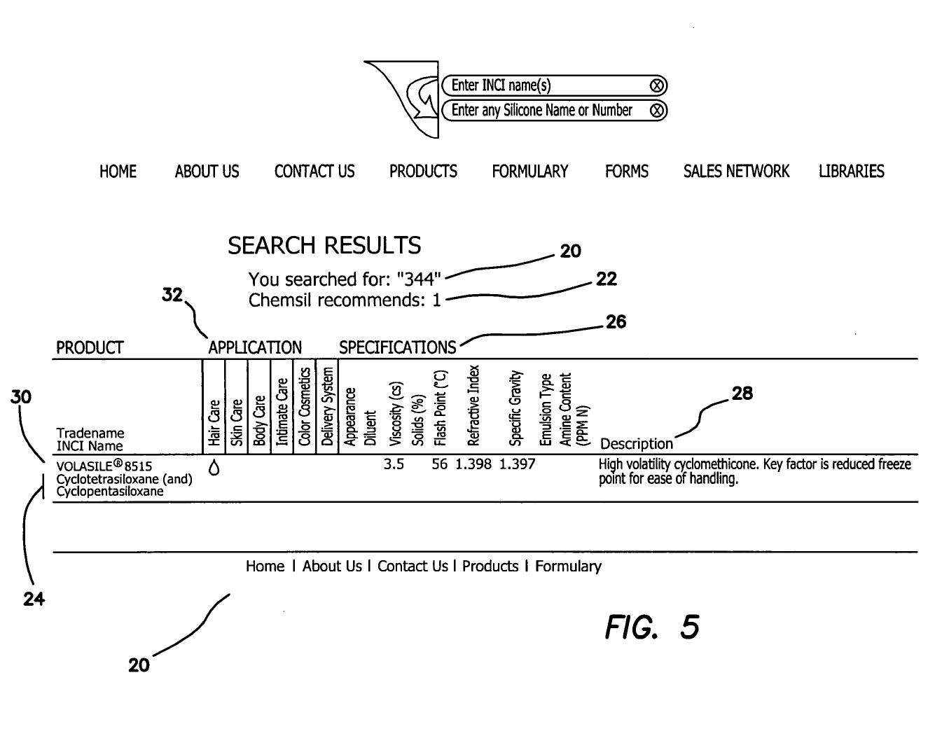

Search results may be listed as shown in FIG. 5. In this example silicone product 344 (Dow Corning Silicone Fluid 344 (cyclomethicone)) is entered as a search term and the search function is initiated. The search engine correlates the Dow Corning product name with the supplier's comparable product Volasil® 8515 cyclotetrasiloxane and cyclopentasiloxane, and displays the business' product name 30 “Volasil® 8515”, and the fact that only one product is recommended as a substitute for the Dow Corning product 22.

Additionally, the INCI name “cylcotetrasiloxane (and) cyclopentasiloxane” 24, the physical and chemical properties of the product 26, and a brief description of the product 28 and its applications 32 are listed in the search results. The product is described as a high volatility cyclomethicone suitable for hair care products having a viscosity of 3.5 cps, a flash point of 56° C., a refractive index of 1.398 and a specific gravity of 1.397.

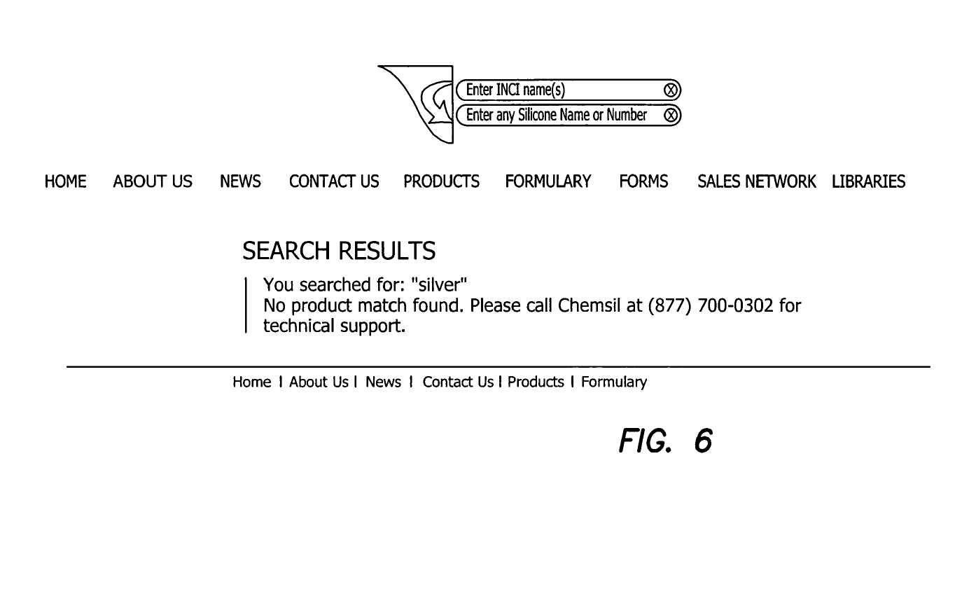

If the search term is not correlated with a product name in the directory listing storage 10b or does not fall within the rule or instructions of the Search engine Sets and Rules, either no search result is displayed, or a “null” result may be sent to the client computer's browser or a screen or message indicating more or less that “no product match was found” is displayed. The screen or entry can also provide a telephone number or web address for further customer support. FIG. 6 shows such a screen in which no product match was found for the search term “silver”.

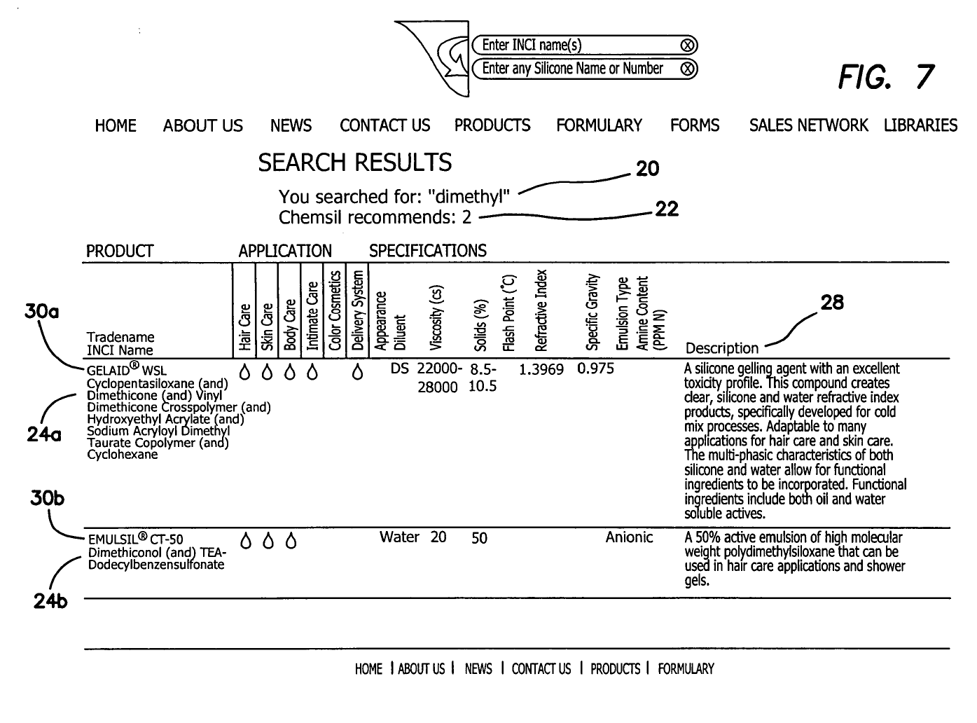

FIG. 7 shows a search result from a query in which the term “dimethyl” was entered in dialog box 14 of FIG. 4.

The search results again display the search term 20, however, in this case the search engine returns two product descriptions corrolating with the search term; a first product trade name 30a and the INCI name of the formulation 24a, and a second product trade name 30b and the INCI name of this second chemical formulation 24b. The recommended applications, specifications and description of each product accompany each product trade name and INCI name.

### Example 3

Those of ordinary skill in the art are aware in light of the present disclosure that there are many possible ways in which to make and implement a search engine application for a business which can accept and correlate competitor's product names (and optionally other identifying information) as a search term for similar or identical products sold by the business. The embodiment that follows is not intended to limit the scope of the invention, which is defined only by the claims that conclude this specification.

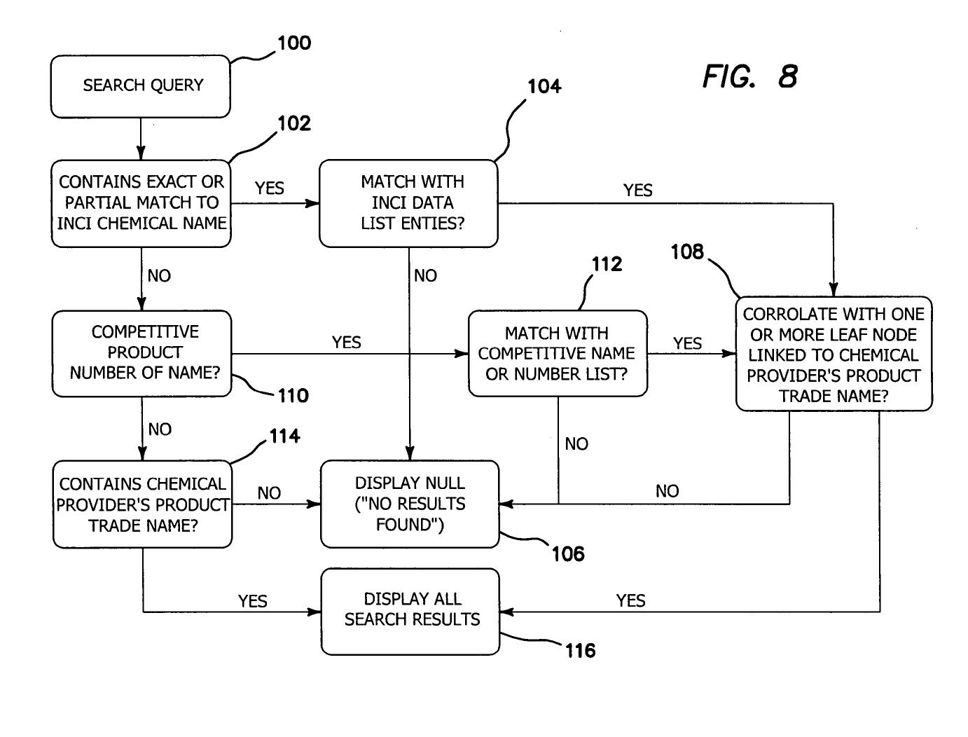

For a chemical product manufacturing, wholesale, retail or distributing business (e.g., a “chemical provider”), for example, in one embodiment, the present invention is directed to a search engine computing application 10 that processes and implements the algorithm shown in FIG. 8, with reference to FIG. 3. A search query 100 is presented by a client computer 1a at a server 3a upon which the search engine computing application 10 is installed. The search query processed by the search engine instruction sets and rules 10b with reference to the chemical compound and formulation directory listing storage 10a. The query is first tested by the search engine instruction sets and rules 10b at decision box 102, according to whether or not it contains an exact or partial INCI chemical name listed in the chemical compound and formulation directory listing storage 10a. If the answer to this question is “no”, then the search query is next tested at decision box 110, explained below. If the answer to this question is “yes” then the search engine instruction sets and rules 10b next test the search query at decision box 104 to determine whether the exact or partial INCI chemical name matches the INCI listings correlating with the chemical provider's products, if the answer to this question is “no”, then the search is essentially over, and a “null’ result is returned, shown at decision box 106, indicating for example that “no product match was found”, and perhaps including an e-mail or telephone number for the searcher to obtain further information.

If the answer to the question at decision box 104 is “yes”, then search engine instruction sets and rules 10b asks whether the search query correlates with a listed product provided by the chemical provider 108. If the answer to this is yes, then the information in the chemical compound and formulation directory listing storage 10a listing each matching product is sent to the client computer as a search result. If the answer is no, the search is again over, and a “null’ result is returned, shown at decision box 106. It will be apparent to those of skill in the art that in some situations the functions of box 102 and box 104 can be combined into a single step, if for example, the INCI chemical names against which the search terms are initially screen are exactly those for which a product listing occurs.

As indicated above, if the answer to the question of decision box 102 is “no”, then the search query is tested at decision box 110 by search engine instruction sets and rules 10b. The question is now asked whether the search term is the identifying name or number of a competitor's product. If the answer to this question is “no”, the search query is then passed to decision box 114, which asks, via search engine instruction sets and rules 10b, whether the search query contains the trade name of one or more of the chemical provider's own products. If the answer to this question is “yes”, then the information in the chemical compound and formulation directory listing storage 10a listing each matching product is sent to the client computer as a search result 116. If the answer is “no”, the search is over, and a “null’ result is returned, shown at decision box 106.

If the answer to the question posed by search engine instruction sets and rules 10b at decision box 110, is “yes”, then the search engine instruction sets and rules 10b asks, as shown by decision box 112, whether the search query matches a competitor's product trade name matching the chemical provider's own products. If the answer is “no”, then a “null” result is returned (see box 106). If the answer is “yes” then the search query is asked whether it correlates with a listed product provided by the chemical provider, as shown at box 108. If the answer to this is yes, then, as before, the information in the chemical compound and formulation directory listing storage 10a listing each matching product is sent to the client computer as a search result 116. If the answer is no, the search is again over, and a “null’ result is returned, shown at decision box 106.

It will be apparent to those of skill in the art that in some situations the functions of box 110 and box 112 can be combined into a single step, if for example, the competitive product names against which the search terms are initially screened at 110 are exactly those for which a product listing occurs.

By referring to this example, it will be clear that steps may be rearranged, added or subtracted from the algorithm, and entirely different algorithms can be made to accomplish the same result of a search engine which matches a competitor's trade names or number with a competing chemical provider's products.

In other embodiments, the methods and apparatus of the present invention may be implemented as part of a computer network such as the Internet having a one or a plurality of server computers representing internet content providers hosting content, such as internet domains. Further, a one or a plurality of users (i.e. client computers) are connected to the computer network through computer hardware and software (e.g. browsers installed on a general purpose computer) such that the user may request, transmit, and receive internet content.

Although the depicted embodiment provides a system and method for searching a chemical product supplier's product directory listing information employing the Internet, those skilled in the art will appreciate that the inventive concepts described herein extend to product directory searching systems utilizing competitive product names as search terms in general, and methods utilizing computer systems having various configurations.

Thus, in q broad sense, the present invention is drawn to a system and method for correlating equivalent chemical products of different manufacturers or sellers. Thus, for example, the search engine comprises a software application to be accessed by one or more users' Internet web browser installed on a client general purpose computer that compares lists of chemical products within a database located on a server (e.g. a mainframe or general purpose computer which receives search queries from client computers) which performs a correlation function in which the search queries are either matched to one or more item of chemical product information and posts search results, or a “null” result is returned.

In another embodiment the present invention is drawn to a method and system for finding alaternative sources of substantially equivalent chemical formulation via a general purpose computer when presented with a search term consisting of a first manufacturer or seller's part number, trade name, or generic formulation for the same or a substantially similar chemical formulation.

In this embodiment a user inputs a “search term” comprising a first manufacturer's, distributor's or seller's (hereinafter the “first” or competitor” party) part number, formula number, product name, generic chemical name, or other substantially well-known identifier for a chemical product or formulation into a general purpose computer-based, preferably an Internet-based, search engine screen.

In an embodiment a search engine algorithm searches a first data set to determine if the first manufacturer's part number, formulation number, generic formula, or other identifier for said chemical product or formulation exists in the first data set.

If the search term is not found in the first data set, either no search result is displayed, or a screen or message indicating more or less that “no product match was found” is displayed. The screen or entry can also provide a telephone number or web address for further customer support.

Entries in the first database are correlated with or defined in a search result listed in a second data set comprising a second manufacturer, distributor or seller's (hereafter the “second party” or “chemical supplier”) equivalent chemical formulation, including the second party's product name and or number. In some cases multiple entries in the first data set will be correlated with, or defined in, a single entry in the second data set. In other cases a single entry in the first data set will be correlated with, or define, a single entry in the second data set. In still other cases a multiple entry in the first data set will be correlated with multiple entries. And in yet other cases a single entry in the first data set is correlated with multiple entries in the second data set.

Once an entry in the second data set has been identified and optionally formatted, this entry is then displayed on the screen as a “search result” of the user's search using the first party's part number, trade name, formula number, or the generic chemical name or other substantially well-known identifier for a chemical product as a “search term”.

The search result may also provide additional information, such as (but not limited to) a list of ingredients, the suitable applications for such chemical formulation or product, and/or relevant chemical, physical, biological and/or safety information concerning the second party's equivalent or substantially equivalent chemical formulation or product.

It will be understood that in certain embodiments a “first data set” and a “second data set” may be comprised in a single list of search and/or search results. Thus, there are many ways known to the person of ordinary skill in the art in which the search engine algorithms described herein may be implemented on a general purpose computer, with the methods expressly described herein being only particular embodiments of such methods.

It will be evident that a person of ordinary skill in the art can, in light of the present disclosure, easily create the lists of product names and correlations between the lists and can make many variations upon this theme once the novel idea is disclosed. The invention described and enabled herein arc intended to encompass the entire scope of search engines that correlate entries from lists according to a customized concordance.

We claim:

1. A method permitting a user to find chemical products made, and/or sold by a chemical supplier that are equivalent or substantially equivalent to products made and/or sold by a competitor of said chemical supplier comprising:
a) entering into a search engine software program or subprogram accessible on an internet web site of a general purpose computer a search term comprising a term selected from the group consisting of a part number, formula number, product trade name, INCI chemical name, formulary name, formulary number, or another substantially well-known identifier for a chemical product or formulation made, sold or marketed by a competitor of a chemical supplier,
b) searching a first data set for an occurrence of said search term,
c) correlating said search term, if present in said first data set, with one or more search result signifying a substantially identical or equivalent chemical compound or formulation,
said search result being present in a second data set and comprising information selected from the group consisting of a part number, formula number, product trade name or number, INCI chemical name, generic chemical name, formulary name, formulary number, or substantially well-known identifier for a chemical product or formulation made, sold or marketed by said chemical supplier, and
d) displaying said search result on an internet web page.

2. The method of claim 1 wherein the search term comprises a trade name.

3. The method of claim 1 wherein the search term comprises a trade number.

4. The method of claim 1 wherein the search term comprises an INCI chemical name.

5. The method of claim 1 wherein the first data set and the second data set are the same.

6. The method of claim 1 wherein the search term is different from the search results.

7. The method of claim 1 wherein the search results comprise more than one item of information.

8. The method of claim 7 wherein the search results contain chemical attributes.

9. The method of claim 1 wherein said search term is entered and the search results displayed using a web browser application.

10. A system permitting a user to finding chemical products offered by a chemical suppler that are equivalent to chemical products offered by a competitor of said chemical supplier comprising:
a search engine application installed on a server connected to the world wide web and accessible by the user by way of a browser application installed on a general purpose computer, wherein said search engine
i) utilizes a search term entered by a user and comprising a term selected from the group consisting of a part number, formula number, product trade name, formulary name, formulary number, and another substantially well-known identifier for a chemical product or formulation made, sold or marketed by a competitor of a chemical supplier,
ii) searches a first server data set for an occurrence of said search term,
iii) correlates said search term, if present in said first data set, with one or more search result signifying an equivalent chemical compound or formulation, said search result being selected from the group consisting of a part number, formula number, product name, generic name, or another substantially well-known identifier for a composition made, sold or marketed by a said chemical supplier, and
iv) displays said search result on the user's web browser application.

11. The system of claim 10 wherein the search term comprises a trade name.

12. The system of claim 10 wherein the search term comprises a trade number.

13. The system of claim 10 wherein the search term comprises an INCI chemical name.

14. The system of claim 10 wherein the first data set and the second data set are the same.

15. The system of claim 10 wherein the search term is different from the search results.

16. The system of claim 10 wherein the search results comprise more than one item of information.

17. The system of claim 10 wherein the search results contain chemical attributes.

18. The system of claim 10 wherein the search results contain safety information.

19. The system of claim 10 wherein the search results contain recommended applications for said chemical products.
